(19) United States
(12) Patent Application Publication
(10) Pub. No.: US 2025/0014564 A1
(43) Pub. Date: Jan. 9, 2025

(54) SOUND OUTPUT DEVICE AND MOBILE BODY

(71) Applicant: Panasonic Automotive Systems Co., Ltd., Kanagawa (JP)

(72) Inventors: Atsuhiro HARA, Osaka (JP); Yoshiyuki HAYASHI, Osaka (JP)

(73) Assignee: Panasonic Automotive Systems Co., Ltd., Kanagawa (JP)

(21) Appl. No.: 18/887,601

(22) Filed: Sep. 17, 2024

Related U.S. Application Data
(63) Continuation of application No. PCT/JP2023/004796, filed on Feb. 13, 2023.

(30) Foreign Application Priority Data
Mar. 31, 2022 (JP) 2022-059220

(51) Int. Cl. G10K 11/18

(52) U.S. Cl. CPC G10K 11/18

(57) ABSTRACT

A sound output device includes: a sound generator that generates, based on a total number of revolutions of an engine, a sound signal representing a sound for accentuating an engine sound emitted by the engine; a vehicle information obtainer that obtains vehicle information indicating a state of a vehicle; a modulation applier that performs, based on the vehicle information, a predetermined process on the sound signal, the predetermined process being a process for which behavior of the vehicle is taken into consideration; and an outputter that outputs the sound signal on which the predetermined process has been performed to a loudspeaker provided in the vehicle.

### CROSS REFERENCE TO RELATED APPLICATIONS

This is a continuation application of PCT International Application No. PCT/JP2023/004796 filed on Feb. 13, 2023, designating the United States of America, which is based on and claims priority of Japanese Patent Application No. 2022-059220 filed on Mar. 31, 2022.

### FIELD

The present disclosure relates to a sound output device and a mobile body.

### BACKGROUND

A sound output device for causing a simulated engine sound that simulates an actual engine sound to be output from a loudspeaker in a vehicle cabin of a vehicle equipped with an engine is known (see Patent Literature (PTL) 1, for example). The simulated engine sound accentuates the actual engine sound emitted from the engine that is heard within the vehicle cabin, thereby allowing a driver to more readily grasp how the vehicle behaves in response to driving operations performed.

### CITATION LIST

### Patent Literature

### PTL 1: Japanese Patent No. 6646080

### SUMMARY

The above-mentioned conventional sound output device can be improved upon.

In view of this, the present disclosure provides a mobile body and a sound output device that can further improve upon the related art.

A sound output device according to one aspect of the present disclosure is a sound output device provided in a mobile body that includes a rotating body that generates rotational driving force, and the sound output device includes: a generator that generates, based on a total number of revolutions of the rotating body, a sound signal representing a sound for accentuating a rotating body sound emitted by the rotating body; an obtainer that obtains mobile body information indicating a state of the mobile body; a processing unit that performs, based on the mobile body information, a predetermined process on the sound signal, the predetermined process being a process for which behavior of the mobile body is taken into consideration; and an outputter that outputs the sound signal on which the predetermined process has been performed to a loudspeaker provided in the mobile body.

It should be noted that these generic or specific aspects may be implemented as a system, a method, an integrated circuit, a computer program, or a computer-readable recording medium, such as a CD-ROM, or may be implemented as any combination of a system, a method, an integrated circuit, a computer program, and a recording medium.

The sound output device and the like according to the present disclosure can further improve upon the related art.

### BRIEF DESCRIPTION OF DRAWINGS

These and other advantages and features of the present disclosure will become apparent from the following description thereof taken in conjunction with the accompanying drawings that illustrate specific embodiments of the present disclosure.

FIG. 1 is a diagram illustrating a vehicle in which a sound output device according to Embodiment 1 is equipped.

FIG. 2 is a block diagram illustrating a configuration of the sound output device according to Embodiment 1.

FIG. 3 is a block diagram illustrating a configuration of a modulation applier of the sound output device according to Embodiment 1.

FIG. 4 is a diagram for describing a function of the modulation applier of the sound output device according to Embodiment 1.

FIG. 5 is a block diagram illustrating a configuration of a sound output device according to a comparative example.

FIG. 6 is a graph illustrating change over time in frequency of a simulated engine sound output from a loudspeaker in the sound output device according to the comparative example.

FIG. 7 is a graph illustrating change over time in frequency of a simulated engine sound output from a loudspeaker in the sound output device according to Embodiment 1.

FIG. 8 is a block diagram illustrating a configuration of a modulation applier of a sound output device according to Embodiment 2.

FIG. 9 is a diagram for describing a function of the modulation applier of the sound output device according to Embodiment 2.

FIG. 10 is a block diagram illustrating a configuration of a sound output device according to Embodiment 3.

FIG. 11 is a graph illustrating change over time in frequency of a simulated engine sound output from a loudspeaker in the sound output device according to Embodiment 3.

FIG. 12 is a graph illustrating change over time in frequency of a simulated engine sound output from a loudspeaker in a sound output device according to a variation of Embodiment 3.

FIG. 13 is a block diagram illustrating a configuration of a sound output device according to Embodiment 4.

### Underlying Knowledge Forming Basis of the Present Disclosure

In relation to the techniques described in the “Background” section, the inventors have found the following issues to be problematic.

As an example of the above-mentioned type of sound output device, a type of sound output device that generates a simulated engine sound based on a number of revolutions of an engine has been proposed. However, in this type of sound output device, the following issues are problematic.

Depending on the type of vehicle (series hybrid vehicle or the like, for example), there are cases where the number of revolutions of the engine is persistently kept constant. In such cases, with the above-mentioned sound output device, the various tones of the actual engine sound and the simulated engine sound will be kept constant regardless of whether the vehicle is accelerating or decelerating. As a result, it is problematic that the sound heard within the vehicle cabin (actual engine sound and simulated engine sound) does not match the behavior of the vehicle, thereby causing the driver to feel a sense of unnaturalness with regard to driving operations performed.

### DESCRIPTION OF EMBODIMENTS

In order to overcome the problematic issues described above, a sound output device according to one aspect of the present disclosure is provided in a mobile body that includes a rotating body that generates rotational driving force, and the sound output device includes: a generator that generates, based on a total number of revolutions of the rotating body, a sound signal representing a sound for accentuating a rotating body sound emitted by the rotating body; an obtainer that obtains mobile body information indicating a state of the mobile body; a processing unit that performs, based on the mobile body information, a predetermined process on the sound signal, the predetermined process being a process for which behavior of the mobile body is taken into consideration; and an outputter that outputs the sound signal on which the predetermined process has been performed to a loudspeaker provided in the mobile body.

According to this aspect, the generator generates the sound signal based on the total number of revolutions of the rotating body, and the processing unit performs, based on the mobile body information, the predetermined process on the sound signal, the predetermined process being a process for which the behavior of the mobile body is taken into consideration. With this, the frequency components of the sound (hereinafter referred to as the “simulated rotating body sound”) for accentuating the actual rotating body sound output from the loudspeaker include components dependent on the rotating body and components dependent on the behavior of the mobile body. Accordingly, even in a case where the total number of revolutions of the rotating body is kept constant, the tone of the simulated rotating body sound output from the loudspeaker changes in accordance with the behavior of the mobile body. As a result, the sound heard within the mobile body (the actual rotating body sound and the simulated rotating body sound output from the loudspeaker) can be made to match the behavior of the mobile body, and the rotating body sound can be effectively accentuated in accordance with the behavior of the mobile body.

For example, the generator may generate a plurality of sound signals representing a plurality of sounds having different frequencies, the plurality of sound signals each being the sound signal, the plurality of sounds each being the sound. The processing unit may perform, as the predetermined process, applying modulation to each of the plurality of sound signals by using a modulating frequency or a modulation degree determined based on the mobile body information, and adding up the plurality of sound signals to which the modulation has been applied. The outputter may output the plurality of sound signals that have been added up to the loudspeaker.

According to this aspect, the rotating body sound can be effectively accentuated, in accordance with the behavior of the mobile body, with a simple configuration.

For example, the modulation may be amplitude modulation (AM) or frequency modulation (FM).

For example, the processing unit may further perform, as the predetermined process, a filtering process on each of the plurality of sound signals to which the modulation has been applied.

According to this aspect, the tone of the simulated rotating body sound output from the loudspeaker can be made to more closely resemble a tone of a sound that matches the behavior of the mobile body.

For example, the processing unit may further perform, as the predetermined process, a filtering process on each of the plurality of sound signals that have been added up.

According to this aspect, the tone of the simulated rotating body sound output from the loudspeaker can be made to more closely resemble a tone of a sound that matches the behavior of the mobile body.

For example, the processing unit may dynamically change a filtering characteristic of the filtering process.

According to this aspect, the tone of the simulated rotating body sound output from the loudspeaker can be effectively made to more closely resemble a tone of a sound that matches the behavior of the mobile body.

For example, the processing unit may perform, as the predetermined process, applying the modulation to each of the plurality of sound signals by using the modulating frequency determined based on the mobile body information, and decreasing the modulating frequency when a maximum value of a frequency of a sound output from the loudspeaker reaches a threshold value.

According to this aspect, the simulated rotating body sound can be used to convey a simulated gear shift effect.

For example, the generator may generate a plurality of sound signals representing a plurality of sounds having different frequencies, the plurality of sound signals each being the sound signal, the plurality of sounds each being the sound. The processing unit may perform, as the predetermined process, generating, based on the mobile body information, an embellished sound signal representing an embellished sound for which the behavior of the mobile body is taken into consideration, and adding up the plurality of sound signals and the embellished sound signal. The outputter may output the plurality of sound signals and the embellished sound signal that have been added up to the loudspeaker.

According to this aspect, the rotating body sound can be effectively accentuated, in accordance with the behavior of the mobile body, with a simple configuration.

For example, the processing unit may perform the predetermined process on the sound signal under a condition that the total number of revolutions of the rotating body reaches a first threshold value, or that an amount of change per unit time of the total number of revolutions of the rotating body exceeds a second threshold value.

According to this aspect, the predetermined process can be performed on the sound signal at a timing that is appropriate, and the processing load placed on the processing unit can be reduced.

For example, a plurality of loudspeakers that include the loudspeaker may be provided in the mobile body. The sound output device may dynamically switch a loudspeaker to which the sound signal is to be output, among the plurality of loudspeakers, the sound signal being a sound signal on which the predetermined process has been performed.

According to this aspect, the simulated rotating body sound can be effectively used to convey the behavior of the mobile body.

A mobile body according to one aspect of the present disclosure is a mobile body that travels in a state in which the mobile body carries a user, and the mobile body includes: a rotating body that generates rotational driving force; any of the above-mentioned sound output devices that output the sound signal representing the sound for accentuating the rotating body sound emitted by the rotating body; and a loudspeaker to which the sound signal received from the sound output device is input.

According to this aspect, in the same manner as described above, the rotating body sound can be effectively accentuated in accordance with the behavior of the mobile body.

It should be noted that these generic or specific aspects may be implemented as a system, a method, an integrated circuit, a computer program, or a computer-readable recording medium, such as a CD-ROM, or may be implemented as any combination of a system, a method, an integrated circuit, a computer program, and a recording medium.

Hereinafter, exemplary embodiments will be specifically described with reference to the drawings.

It should be noted that the embodiments described below merely illustrate general or specific examples of the present disclosure. The numerical values, shapes, materials, elements, the arrangement and connection of the elements, steps, the order of the steps, etc., described in the following embodiments are mere examples, and are therefore not intended to limit the present disclosure. Accordingly, among elements in the following embodiments, those not appearing in any of the independent claims that indicate the broadest concepts of the present disclosure will be described as optional elements.

### Embodiment 1

### [1-1. Configuration of Sound Output Device]

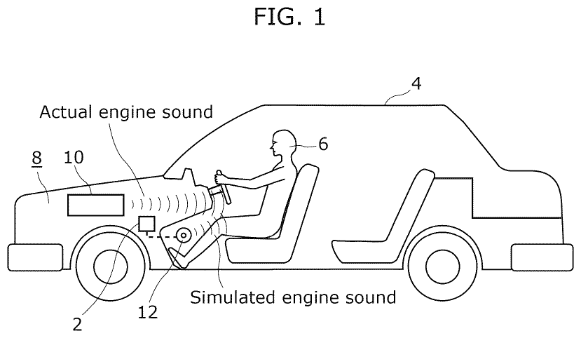

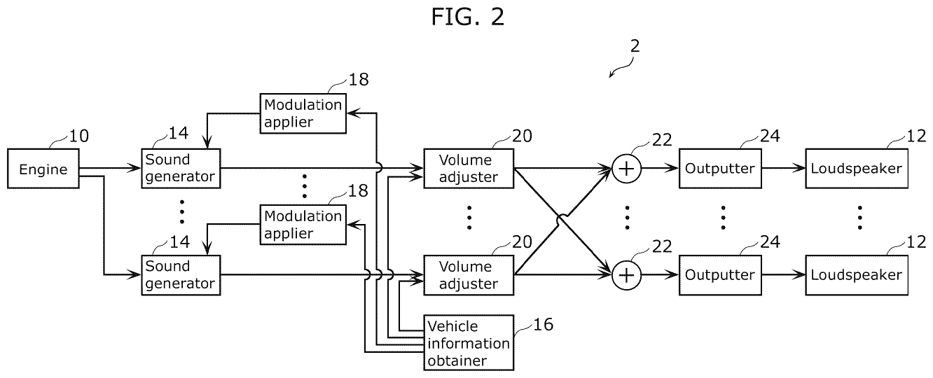

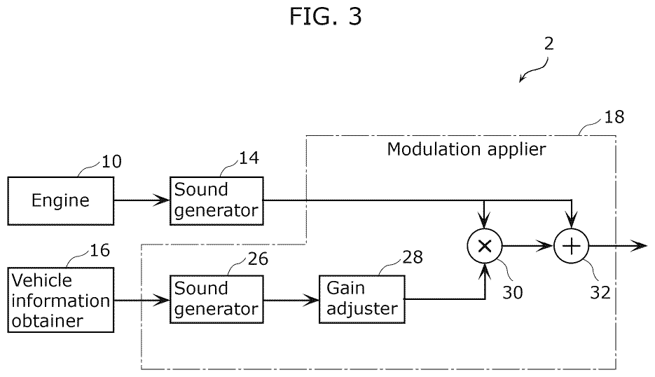

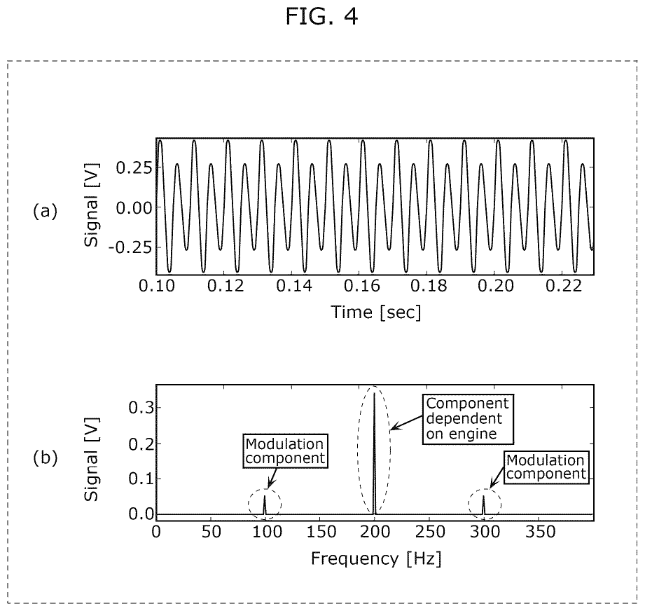

A configuration of sound output device 2 according to Embodiment 1 will be described with reference to FIG. 1 through FIG. 4. FIG. 1 is a diagram illustrating vehicle 4 in which sound output device 2 according to Embodiment 1 is equipped. FIG. 2 is a block diagram illustrating a configuration of sound output device 2 according to Embodiment 1. FIG. 3 is a block diagram illustrating a configuration of modulation applier 18 of sound output device 2 according to Embodiment 1. FIG. 4 is a diagram for describing a function of modulation applier 18 of sound output device 2 according to Embodiment 1.

As illustrated in FIG. 1, sound output device 2 is equipped in vehicle 4 that is, for example, an automobile or the like. Vehicle 4 is an example of a mobile body that travels in a state where the mobile body is carrying a user, such as driver 6. Engine room 8 of vehicle 4 is equipped with engine 10 (an example of a rotating body) that generates rotational driving force. When vehicle 4 is, for example, a series hybrid vehicle, the drive source of vehicle 4 is a motor (not illustrated in the figure), and engine 10 is used to generate power. Furthermore, when vehicle 4 is, for example a continuously variable transmission (CVT) vehicle, the drive source of vehicle 4 is engine 10.

A plurality of loudspeakers 12 are equipped in the vehicle cabin of vehicle 4. The plurality of loudspeakers 12 include, for example, a right-front loudspeaker disposed in a front door on the right side (driver side), a left-front loudspeaker disposed in a front door on the left side (passenger side), a right-rear loudspeaker disposed in a rear door on the right side, and a left-rear loudspeaker disposed in a rear door on the left side. Note that for illustrative purposes, only one loudspeaker 12 (right-front loudspeaker) is shown in FIG. 1.

Sound output device 2 is a device for causing a plurality of loudspeakers 12 to output a simulated engine sound for accentuating an actual engine sound (an example of a rotating body sound) emitted from engine 10 that is heard within the vehicle cabin of vehicle 4. It should be noted that the simulated engine sound is a sound that mimics the actual engine sound. In this manner, the actual engine sound is accentuated by the simulated engine sound, thereby allowing driver 6 to more readily grasp how vehicle 4 behaves in response to driving operations performed, thus enhancing the driving experience of driver 6.

As illustrated in FIG. 2, sound output device 2 includes a plurality of sound generators 14 (an example of generators), vehicle information obtainer 16, a plurality of modulation appliers 18 (an example of processing units), a plurality of volume adjusters 20, a plurality of adders 22 (an example of processing units), and a plurality of outputters 24.

Each of the plurality of sound generators 14 obtains rotational speed information indicating the number of revolutions of engine 10 from a rotational speed sensor (not illustrated in the figure) disposed in engine 10. The plurality of sound generators 14 generate a plurality of sound signals (digital signals) that each represent a plurality of simulated engine sounds (an example of a plurality of sounds) of frequencies that are different from each other based on the number of revolutions of engine 10 indicated by the rotational speed information. Each of the frequencies of the plurality of simulated engine sounds is, for example, a frequency that is a second harmonic, 2.5th harmonic, fourth harmonic, or the like, where a frequency synchronized with the number of revolutions of engine 10 is the first harmonic.

Vehicle information obtainer 16 obtains vehicle information (an example of mobile body information) indicating the state of vehicle 4. Vehicle information is, for example, information that indicates the vehicle speed of vehicle 4, acceleration of vehicle 4, rotational speed of a tire, the number of revolutions of the tire, the number of revolutions of a drive shaft, the number of revolutions of a propeller shaft, positioning information of a global positioning system (GPS), image data captured by a dashcam, or the like. This vehicle information is information that changes in accordance with the behavior (acceleration, deceleration, or the like) of vehicle 4.

Each of the plurality of modulation appliers 18 is provided in one-to-one correspondence with one of the plurality of sound generators 14. Each of the plurality of modulation appliers 18 applies amplitude modulation (AM) to a corresponding one of the plurality of sound signals generated by a corresponding one of the plurality of sound generators 14 by applying a modulating frequency determined based on the vehicle information received from vehicle information obtainer 16. That is to say, each of the plurality of modulation appliers 18 performs a predetermined process on a corresponding one of the plurality of sound signals for which the behavior of vehicle 4 based on the vehicle information is taken into consideration. Specifically, each of the plurality of modulation appliers 18 applies AM modulation to a sound signal by using a modulating frequency determined based on the vehicle information such that the frequency of the simulated engine sound increases in conjunction with acceleration of vehicle 4, for example.

As illustrated in FIG. 3, each of the plurality of modulation appliers 18 includes sound generator 26, gain adjuster 28, multiplier 30, and adder 32. Sound generator 26 generates a sound signal (digital signal) that represents a simulated engine sound based on the vehicle information received from vehicle information obtainer 16. Gain adjuster 28 adjusts the gain of the sound signal generated by sound generator 26. Multiplier 30 multiplies a sound signal generated by sound generator 14 by the sound signal for which gain has been adjusted by gain adjuster 28. Adder 32 adds an amplitude of the sound signal generated by sound generator 14 to an amplitude of the sound signal resulting from the multiplication performed by multiplier 30.

Accordingly, an example of a waveform of a sound signal to which AM modulation has been applied by using a modulating frequency determined based on vehicle information is illustrated in (a) in FIG. 4. In this case, as illustrated in (b) in FIG. 4, frequency components of the sound signal to which AM modulation has been applied include a component dependent on engine 10 and a plurality of modulation components dependent on the behavior of vehicle 4.

Note that in the present embodiment, although each of the plurality of modulation appliers 18 applies AM modulation to a corresponding one of the plurality of sound signals by using a modulating frequency determined based on the vehicle information received from vehicle information obtainer 16, this example is not limiting, and AM modulation may be applied to a corresponding one of the plurality of sound signals by using a modulation degree determined based on the vehicle information received from vehicle information obtainer 16. By changing the modulation degree, the size of the modulation components indicated in (b) in FIG. 4 can be changed, thereby allowing the size of the components of the simulated engine sound to be controlled.

Each of the plurality of volume adjusters 20 is provided in one-to-one correspondence with one of the plurality of sound generators 14. Each of the plurality of volume adjusters 20 adjusts, based on the vehicle information received from vehicle information obtainer 16, the volume of a corresponding one of the plurality of sound signals to which AM modulation has been applied that has been received from a corresponding one of the plurality of sound generators 14. Specifically, each volume adjuster 20 adjusts the volume of the sound signal received from sound generator 14 to which AM modulation has been applied in such a manner that the higher the vehicle speed of vehicle 4 is, the louder the volume is made to be, for example.

Each of the plurality of adders 22 adds up the plurality of sound signals, each of which has a volume that has been adjusted by a corresponding one of the plurality of volume adjusters 20.

Each of the plurality of outputters 24 is provided in one-to-one correspondence with one of the plurality of adders 22. Each of the plurality of outputters 24 outputs the plurality of sound signals that have been added up by a corresponding one of the plurality of adders 22 to a corresponding one of the plurality of loudspeakers 12. It should be noted that each of the plurality of outputters 24 converts the plurality of sound signals that have been added up by a corresponding one of the plurality of adders 22 from a digital signal to an analog signal, and amplifies and outputs the plurality of sound signals to loudspeaker 12.

Each of the plurality of loudspeakers 12 outputs a simulated engine sound based on the sound signal received from a corresponding one of the plurality of outputters 24. Accordingly, each of the plurality of loudspeakers 12 outputs a simulated engine sound that not only accounts for the number of revolutions of engine 10, but for which the behavior of vehicle 4 is taken into consideration as well.

The actual engine sound emitted from engine 10 that is heard within the vehicle cabin of vehicle 4 is accentuated by the simulated engine sound output from each of the plurality of loudspeakers 12. It should be noted that weighting of parameters related to the volume and the like of the simulated engine sound output from each loudspeaker 12 may be performed for each loudspeaker 12 in order to more effectively accentuate the actual engine sound.

### [1-2. Advantageous Effects]

Next, the advantageous effects achieved by sound output device 2 according to Embodiment 1 will be described by comparing sound output device 2 according to Embodiment 1 with sound output device 100 according to a comparative example.

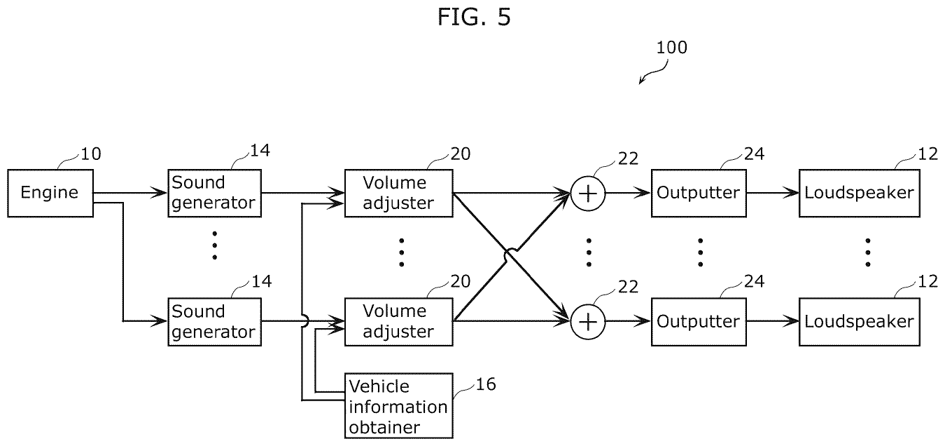

Here, a configuration of sound output device 100 according to the comparative example will be described with reference to FIG. 5. FIG. 5 is a block diagram illustrating a configuration of sound output device 100 according to the comparative example. Note that in FIG. 5, elements that are the same as elements in sound output device 2 according to Embodiment 1 are given the same reference signs and description thereof will be omitted.

As illustrated in FIG. 5, sound output device 100 according to the comparative example is different from sound output device 2 according to Embodiment 1 in that sound output device 100 according to the comparative example does not include a plurality of modulation appliers 18. Accordingly, the simulated engine sound output from each of the plurality of loudspeakers 12 in sound output device 100 according to the comparative example is a simulated engine sound for which only the number of revolutions of engine 10 is taken into consideration.

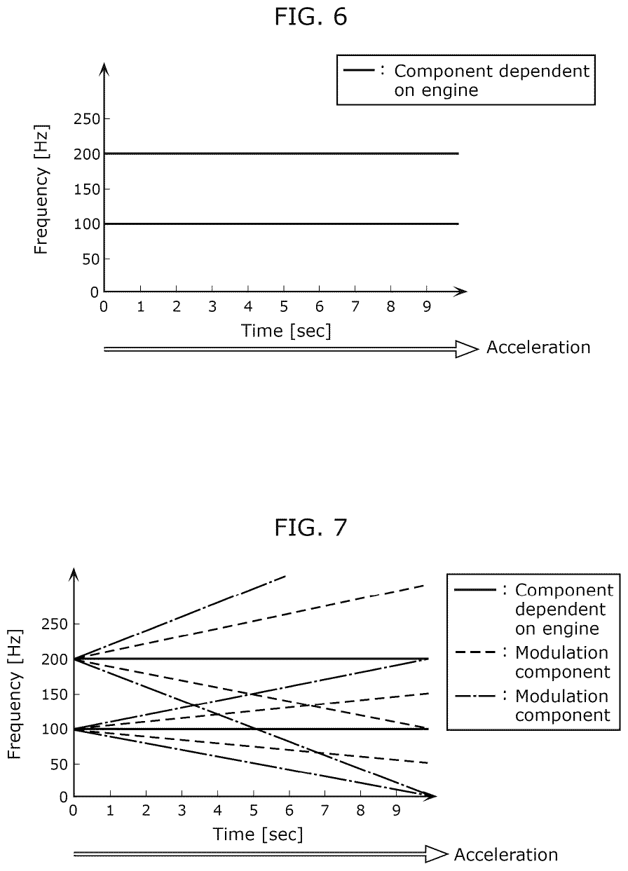

In sound output device 100 according to the comparative example, the change over time in frequency of the simulated engine sound output from each of the plurality of loudspeakers 12 is as illustrated in FIG. 6, for example. FIG. 6 is a graph illustrating change over time in frequency of the simulated engine sound output from loudspeaker 12 in sound output device 100 according to the comparative example. Note that in FIG. 6, vehicle 4 begins accelerating from the point in time indicated as “0” seconds (sec) in a state where the number of revolutions of engine 10 is kept constant at 2,000 rpm.

When vehicle 4 is, for example, a series hybrid vehicle, the number of revolutions of engine 10 is persistently kept constant. Furthermore, when vehicle 4 is, for example, a CVT vehicle, the number of revolutions of engine 10 rises and immediately reaches and stays at an upper-limit value when vehicle 4 accelerates. In sound output device 100 according to the comparative example, in cases where the number of revolutions of engine 10 is kept constant in this manner, as illustrated in FIG. 6, since the frequency components of the simulated engine sound output from each of the plurality of loudspeakers 12 only include components dependent on engine 10, the frequencies of the simulated engine sound are kept constant at 100 Hz and 200 Hz, for example. As a result, since the various tones of the actual engine sound and the simulated engine sound are kept constant even when vehicle 4 is accelerating, the sound heard within the vehicle cabin of vehicle 4 (actual engine sound and simulated engine sound) will not match the behavior of vehicle 4, thereby problematically causing driver 6 to feel a sense of unnaturalness with regard to driving operations performed.

In view of this, as described above, in sound output device 2 according to Embodiment 1, a simulated engine sound that not only accounts for the number of revolutions of engine 10, but for which the behavior of vehicle 4 is taken into consideration as well, is output from each of the plurality of loudspeakers 12. Accordingly, in sound output device 2 according to Embodiment 1, the change over time in frequency of simulated engine sound output from each of the plurality of loudspeakers 12 is, for example, as illustrated in FIG. 7. FIG. 7 is a graph illustrating change over time in frequency of the simulated engine sound output from loudspeaker 12 in sound output device 2 according to Embodiment 1. Note that in FIG. 7, vehicle 4 begins accelerating from the point in time indicated as “0” seconds (sec) in a state where the number of revolutions of engine 10 is kept constant at 2,000 rpm.

In sound output device 2 according to Embodiment 1, even in cases where the number of revolutions of engine 10 is kept constant due to vehicle 4 being, for example, a series hybrid vehicle or a CVT vehicle, since the frequency components of the simulated engine sound output from each of the plurality of loudspeakers 12 include components dependent on engine 10 and a plurality of modulation components dependent on the behavior of vehicle 4, as illustrated in FIG. 7, the frequencies of the simulated engine sound change with the passing of time (i.e., in accordance with the behavior of vehicle 4). More specifically, as illustrated in FIG. 7, although the frequencies of the components dependent on the engine (100 Hz and 200 Hz) are kept constant, the various frequencies of the plurality of modulation components begin to rise or fall relative to the components dependent on the engine from the point in time indicated as “0” seconds (sec).

As a result, since the tone of the simulated engine sound changes in conjunction with acceleration of vehicle 4, the sound heard within the vehicle cabin of vehicle 4 (actual engine sound and simulated engine sound) matches the behavior of vehicle 4, thereby allowing driver 6 to more readily grasp how the vehicle behaves in response to driving operations performed, thus enhancing the driving experience of driver 6. Consequently, sound output device 2 according to Embodiment 1 achieves the advantageous effect of being able to effectively accentuate engine sound in accordance with the behavior of vehicle 4.

It should be noted that although it was described in the present embodiment that the above-mentioned advantageous effect can be achieved in cases where the number of revolutions of engine 10 is kept constant, this example is not limiting, and the above-mentioned advantageous effect can be achieved even in cases where the number of revolutions of engine 10 suddenly fluctuates. In this case, the amount of change per unit time of the number of revolutions of engine 10 may be monitored, and each of the plurality of modulation appliers 18 may be caused to activate when the amount of change per unit time of the number of revolutions of engine 10 exceeds a threshold value (an example of a second threshold value).

### Embodiment 2

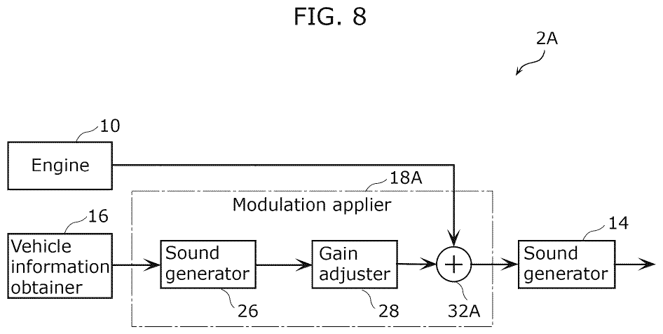

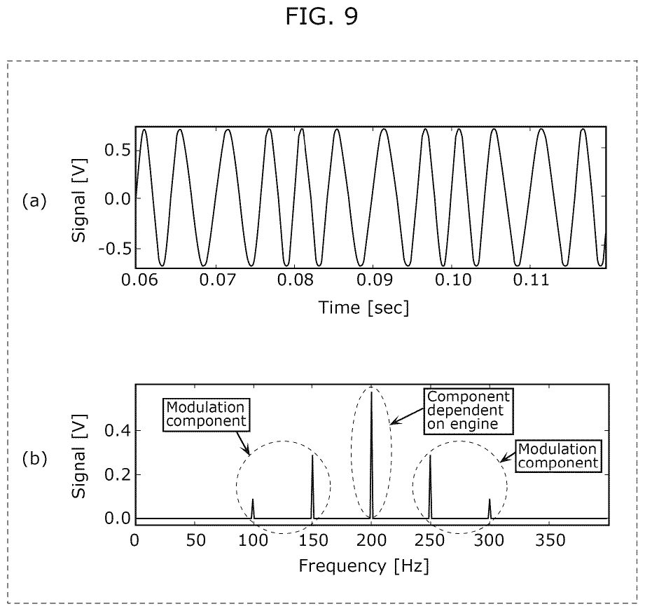

A configuration of sound output device 2A according to Embodiment 2 will be described with reference to FIG. 8 and FIG. 9. FIG. 8 is a block diagram illustrating a configuration of modulation applier 18A of sound output device 2A according to Embodiment 2. FIG. 9 is a diagram for describing a function of modulation applier 18A of sound output device 2A according to Embodiment 2. Note that in the embodiment described below, elements that are the same as elements in the above-mentioned Embodiment 1 are given the same reference signs and description thereof will be omitted.

In sound output device 2A according to Embodiment 2, the configuration of modulation applier 18A is different from that of the above-mentioned Embodiment 1. Specifically, modulation applier 18A applies frequency modulation (FM) to a sound signal by using a modulating frequency determined based on vehicle information received from vehicle information obtainer 16. That is to say, modulation applier 18A performs, based on the vehicle information, a predetermined process on the sound signal for which the behavior of vehicle 4 is taken into consideration.

As illustrated in FIG. 8, modulation applier 18A includes sound generator 26, gain adjuster 28, and adder 32A. Sound generator 26 generates a sound signal that represents a simulated engine sound based on the vehicle information received from vehicle information obtainer 16. Gain adjuster 28 adjusts the gain of the sound signal generated by sound generator 26. Adder 32A adds a frequency synchronized with the number of revolutions of engine 10 indicated by rotational speed information to a frequency of the sound signal for which gain has been adjusted by gain adjuster 28. Adder 32A outputs an addition result to sound generator 14. Accordingly, FM modulation is applied to the sound signal generated by sound generator 14.

Accordingly, an example of a sound signal to which FM modulation has been applied by using a modulating frequency determined based on vehicle information is illustrated in (a) in FIG. 9. In this case, as illustrated in (b) in FIG. 9, frequency components of the sound signal to which FM modulation has been applied include a component dependent on engine 10 and a plurality of modulation components dependent on the behavior of vehicle 4 (see FIG. 1). Consequently, the same advantageous effect as that of the above-mentioned Embodiment 1 can also be achieved in the present embodiment.

### Embodiment 3

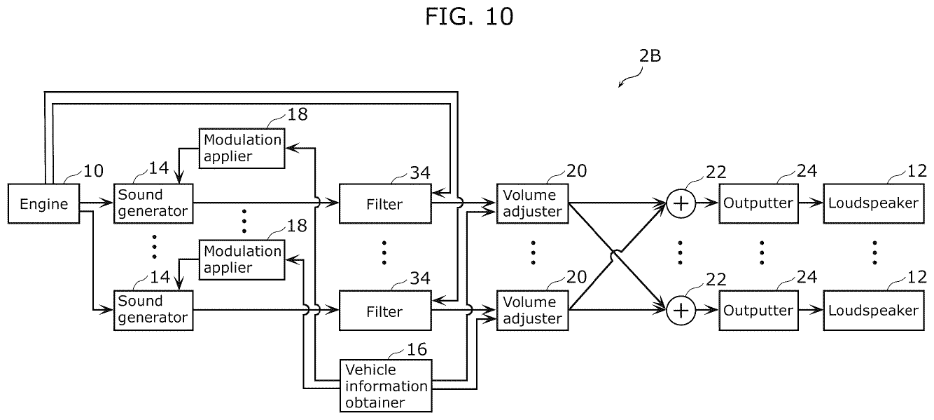

A configuration of sound output device 2B according to Embodiment 3 will be described with reference to FIG. 10. FIG. 10 is a block diagram illustrating a configuration of sound output device 2B according to Embodiment 3.

As illustrated in FIG. 10, sound output device 2B according to Embodiment 3 includes a plurality of filters 34 in addition to the elements described in the above-mentioned Embodiment 1. Each of the plurality of filters 34 is provided in one-to-one correspondence with one of a plurality of sound generators 14. Each of the plurality of filters 34 performs a filtering process on a corresponding one of a plurality of sound signals, received from a corresponding one of the plurality of sound generators 14, to which AM modulation has been applied based on rotational speed information received from a rotational speed sensor (not illustrated in the figure). Specifically, each of the plurality of filters 34 is a high-pass filter that, from among the frequency components of the sound signal, attenuates only the frequency components that are at or below a frequency synchronized with the number of revolutions indicated by the rotational speed information.

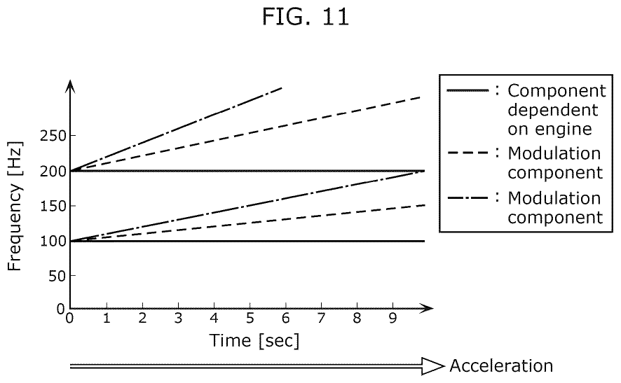

In sound output device 2B according to Embodiment 3, the change over time in frequency of a simulated engine sound output from each of the plurality of loudspeakers 12 is as illustrated in FIG. 11, for example. FIG. 11 is a graph illustrating change over time in frequency of the simulated engine sound output from loudspeaker 12 in sound output device 2B according to Embodiment 3. Note that in FIG. 11, vehicle 4 (see FIG. 1) begins accelerating from the point in time indicated as “0” seconds (sec) in a state where the number of revolutions of engine 10 is kept constant at 2,000 rpm.

As illustrated in FIG. 11, the plurality of filters 34 remove low frequency modulation components from among the frequency components of the simulated engine sound. More specifically, although there are a plurality of modulation components that begin to fall in terms of frequency in relation to the components dependent on the engine (100 Hz and 200 Hz) from the point in time indicated as “0” seconds (sec) in the above-mentioned FIG. 7, in FIG. 11, this plurality of modulation components have been removed. Accordingly, the same advantageous effect of the above-mentioned Embodiment 1 can be achieved, and the tone of the simulated engine sound can be made to more closely resemble a tone of a sound that matches the behavior of vehicle 4, thereby making it possible to more effectively convey the degree of acceleration of vehicle 4.

Note that in the present embodiment, although a filtering process is performed on each of the plurality of sound signals received from the plurality of sound generators 14 to which AM modulation has been applied, this example is not limiting, and a filtering process may be performed on the plurality of sound signals that have been added up by adders 22. Furthermore, when performing the filtering process, filtering characteristics (cut-off frequency and the like, for example) may be changed dynamically. Accordingly, the tone of the simulated engine sound can effectively be made to more closely resemble a tone of a sound that matches the behavior of vehicle 4.

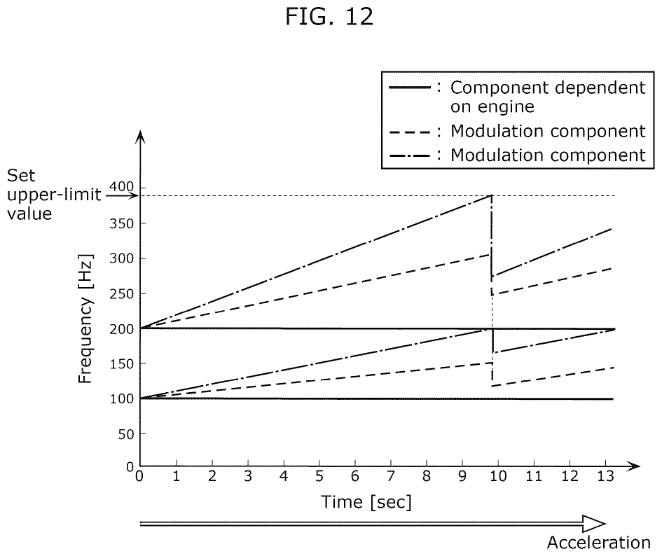

Furthermore, FIG. 12 is a graph illustrating change over time in frequency of a simulated engine sound output from loudspeaker 12 in sound output device 2B according to a variation of Embodiment 3. As illustrated in FIG. 12, when a maximum value of the frequencies of the simulated engine sound reaches a set upper-limit value (an example of a threshold value), control may be performed to decrease the modulating frequency. Accordingly, the simulated engine sound can be used to convey a simulated gear shift effect. Furthermore, this can also be effective when there are restrictions on the frequencies that can be generated due to system constraints.

### Embodiment 4

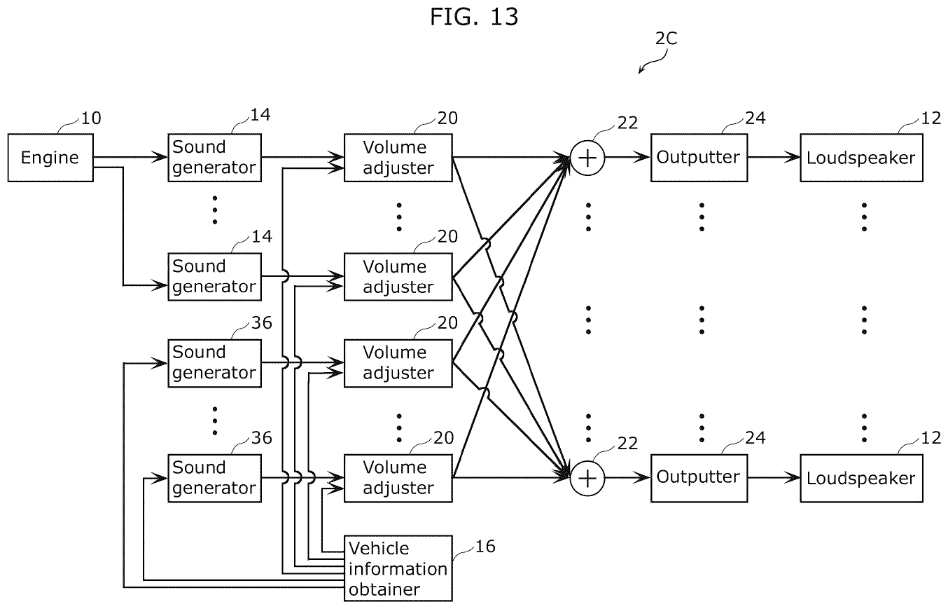

A configuration of sound output device 2C according to Embodiment 4 will be described with reference to FIG. 13. FIG. 13 is a block diagram illustrating a configuration of sound output device 2C according to Embodiment 4.

As illustrated in FIG. 13, sound output device 2C according to Embodiment 4 includes a plurality of sound generators 14, vehicle information obtainer 16, a plurality of sound generators 36 (an example of processing units), a plurality of volume adjusters 20, a plurality of adders 22 (an example of processing units), and a plurality of outputters 24.

Each of the plurality of sound generators 36 obtains vehicle information from vehicle information obtainer 16. Each of the plurality of sound generators 36 generates, based on the vehicle information, a plurality of embellished sound signals that each represent a plurality of embellished sounds that each have a frequency that is different from each other. Each of the plurality of embellished sounds is a sound for which the behavior of vehicle 4 (see FIG. 1) is taken into consideration to simulate the actual engine sound. Specifically, each of the plurality of sound generators 36 generates, based on the vehicle information, an embellished sound in such a manner that the frequencies of the embellished sound increase in conjunction with acceleration of vehicle 4, for example. It should be noted that each of the frequencies of the plurality of embellished sounds is, for example, a frequency that is a second harmonic, 2.5th harmonic, fourth harmonic, or the like, where a frequency synchronized with the number of revolutions of engine 10 is the first harmonic.

Each of the plurality of volume adjusters 20 is provided in one-to-one correspondence with one of the plurality of sound generators 14 or one of the plurality of sound generators 36. Each of the plurality of volume adjusters 20 adjusts, based on the vehicle information received from vehicle information obtainer 16, the volume of a corresponding one of the plurality of sound signals received from a corresponding one of the plurality of sound generators 14, or a corresponding one of the plurality of embellished sound signals received from a corresponding one of the plurality of sound generators 36.

Each of the plurality of adders 22 adds up the plurality of sound signals and the plurality of embellished sound signals, each of which has a volume that has been adjusted by a corresponding one of the plurality of volume adjusters 20. That is to say, the plurality of sound generators 36 and the plurality of adders 22 perform a predetermined process, for which the behavior of vehicle 4 is taken into consideration, on the plurality of sound signals.

Each of the plurality of outputters 24 outputs the plurality of sound signals and the plurality of embellished sound signals that have been added up by a corresponding one of the plurality of adders 22 to a corresponding one of the plurality of loudspeakers 12. Accordingly, each of the plurality of loudspeakers 12 outputs a simulated engine sound that not only accounts for the number of revolutions of engine 10, but for which the behavior of vehicle 4 is taken into consideration as well.

Consequently, the same advantageous effect as that of the above-mentioned Embodiment 1 can also be achieved in the present embodiment.

### Other Variations

Although sound output devices and mobile bodies according to one or more aspects are described above based on the foregoing embodiments, the present disclosure is not limited to the above-mentioned embodiments. Forms obtained by various modifications to the foregoing embodiments conceivable by those skilled in the art or forms obtained by combining elements in different embodiments or variations, so long as they do not depart from the essence of the present disclosure, may be included in the one or more aspects.

Although cases where sound output device 2 (sound output device 2A, sound output device 2B, and sound output device 2C) are equipped in vehicle 4 have been described in the above-mentioned embodiments, these examples are not limiting, and sound output device 2 (sound output device 2A, sound output device 2B, and sound output device 2C) may, for example, be equipped in mobile bodies, such as airplanes, trains, marine vessels, or the like.

Furthermore, although cases where vehicle 4 is an automobile have been described in the above-mentioned embodiments, these examples are not limiting, and vehicle 4 may, for example, be of a variety of types of vehicles, such as construction machinery, agricultural machinery, or the like.

Furthermore, although a predetermined process for which the behavior of vehicle 4 is taken into consideration is performed on the sound signals in the above-mentioned embodiments, rotational speed information received from a rotational speed sensor may be monitored, and a predetermined process for which the behavior of vehicle 4 is taken into consideration may be performed under a condition that the number of revolutions of engine 10 indicated by the rotational speed information reaches an upper-limit value or a given set value (examples of a first threshold value). For example, in the above-mentioned Embodiment 1, operation of each of the plurality of modulation appliers 18 may be switched from off to on at a timing when the number of revolutions of engine 10 reaches an upper-limit value or a given set value. Accordingly, processing load incurred when the predetermined process is performed on the sound signal can be reduced.

Furthermore, although the frequencies of the simulated engine sound are controlled in accordance with the behavior of vehicle 4 in the above-mentioned embodiments, these examples are not limiting, and the volume of the simulated engine sound may be controlled in accordance with the behavior of vehicle 4. That is to say, a predetermined process for which the behavior of vehicle 4 is taken into consideration may be performed on the sound signals in such a manner that the volume of the simulated engine sound increases in conjunction with acceleration of vehicle 4.

Furthermore, although all of the plurality of sound generators 14 are operated in the above-mentioned embodiments, these examples are not limiting, and the frequencies of the simulated engine sound may be controlled in accordance with the behavior of vehicle 4 by switching operation of each of the plurality of sound generators 14 on or off as needed. Alternatively, the plurality of outputters 24 may use the simulated engine sound to convey the behavior (acceleration or deceleration) of vehicle 4 by dynamically switching a loudspeaker 12 to which the simulated engine sound is to be output, among a plurality of loudspeakers 12. For example, the simulated engine sound may be output from the front loudspeakers when vehicle 4 is accelerating, and the simulated engine sound may be output from the rear loudspeakers when vehicle 4 is decelerating. Conversely, the simulated engine sound may be output from the rear loudspeakers when vehicle 4 is accelerating, and the simulated engine sound may be output from the front loudspeakers when vehicle 4 is decelerating.

### Other Embodiments, Etc.

In the above-mentioned embodiments, each element may be configured as dedicated hardware, or may be implemented by executing a software program suitable for each element. Alternatively, the elements may be implemented by a program executor, such as a CPU or a processor, reading and executing a software program recorded in a recording medium, such as a hard disk or semiconductor memory.

Furthermore, the present disclosure also includes the following cases.

(1) More specifically, each of the preceding devices may be a computer system configured with a microprocessor, read-only memory (ROM), random-access memory (RAM), a hard disk unit, a display unit, a keyboard, a mouse, or the like. The RAM or the hard disk unit stores a computer program. The microprocessor operates according to the computer program, so that a function of the devices is achieved. Here, the computer program includes a plurality of instruction codes indicating instructions to be given to the computer so as to achieve a specific function.

(2) Some or all of the elements included in each of the preceding devices may be realized in a single system large-scale integration (LSI). The system LSI is a super multifunctional LSI manufactured by integrating a plurality of elements onto a single chip. To be more specific, the system LSI is a computer system configured with a microprocessor, ROM, RAM, or the like, for example. The ROM stores a computer program. The microprocessor loads the computer program from ROM to RAM, and operates according to the computer program loaded, so that a function of the system LSI is achieved.

(3) Some or all of the elements included in the preceding devices may be configured as an IC card or stand-alone module that can be inserted and removed from the corresponding device. The IC card or the module is a computer system that includes a microprocessor, ROM, RAM, and the like. The IC card or the module may include the above-mentioned super multifunctional LSI. The microprocessor operates according to the computer program, so that a function of the IC card or the module is achieved. The IC card or the module may be tamper-resistant.

(4) The present disclosure may be implemented by the methods described above. Furthermore, the present disclosure may be implemented by a computer program for causing a computer to execute these methods, or may be a digital signal of the computer program.

Moreover, the present disclosure may be implemented by the aforementioned computer program or digital signal recorded on a computer-readable recording medium, such as a flexible disk, hard disk, a compact disc (CD)-ROM, magneto-optical (MO) disc, digital video disc (DVD), DVD read-only memory (DVD-ROM), DVD random-access memory (DVD-RAM), Blu-ray disc (BD), or semiconductor memory, for example. Moreover, the present disclosure may be the digital signal recorded on the above-mentioned recording media.

Furthermore, the present disclosure may be the above-mentioned computer program or the digital signal transmitted via an electric communication line, a wireless or wired communication line, a network, such as the Internet, data broadcasting, and the like.

Additionally, the present disclosure may be a computer system including a microprocessor and memory. The memory may store the above-mentioned computer program, and the microprocessor may operate according to the computer program.

Moreover, by transferring the recording medium having the above-mentioned program or digital signal recorded thereon or by transferring the above-mentioned program or digital signal via the above-mentioned network or the like, the present disclosure may be implemented by a different independent computer system.

(5) The preceding embodiments and the preceding variations may be combined.

While various embodiments have been described herein above, it is to be appreciated that various changes in form and detail may be made without departing from the spirit and scope of the present disclosure as presently or hereafter claimed.

### Further Information About Technical Background to This Application

The disclosures of the following patent applications including specification, drawings, and claims are incorporated herein by reference in their entirety: Japanese Patent Application No. 2022-059220 filed on Mar. 31, 2022, and PCT International Application No. PCT/JP2023/004796 filed on Feb. 13, 2023.

### Industrial Applicability

The present disclosure can, for example, be applied to a sound output device that outputs a simulated engine sound for accentuating an engine sound to a loudspeaker in a vehicle.

1. A sound output device provided in a mobile body that includes a rotating body that generates rotational driving force, the sound output device comprising:
a generator that generates, based on a total number of revolutions of the rotating body, a sound signal representing a sound for accentuating a rotating body sound emitted by the rotating body;
an obtainer that obtains mobile body information indicating a state of the mobile body;
a processing unit that performs, based on the mobile body information, a predetermined process on the sound signal, the predetermined process being a process for which behavior of the mobile body is taken into consideration; and
an outputter that outputs the sound signal on which the predetermined process has been performed to a loudspeaker provided in the mobile body.

2. The sound output device according to claim 1, wherein
the generator generates a plurality of sound signals representing a plurality of sounds having different frequencies, the plurality of sound signals each being the sound signal, the plurality of sounds each being the sound,
the processing unit performs, as the predetermined process, applying modulation to each of the plurality of sound signals by using a modulating frequency or a modulation degree determined based on the mobile body information, and adding up the plurality of sound signals to which the modulation has been applied, and
the outputter outputs the plurality of sound signals that have been added up to the loudspeaker.

3. The sound output device according to claim 2, wherein
the modulation is amplitude modulation (AM) or frequency modulation (FM).

4. The sound output device according to claim 2, wherein
the processing unit further performs, as the predetermined process, a filtering process on each of the plurality of sound signals to which the modulation has been applied.

5. The sound output device according to claim 2, wherein
the processing unit further performs, as the predetermined process, a filtering process on each of the plurality of sound signals that have been added up.

6. The sound output device according to claim 4, wherein
the processing unit dynamically changes a filtering characteristic of the filtering process.

7. The sound output device according to claim 4, wherein
the processing unit performs, as the predetermined process, applying the modulation to each of the plurality of sound signals by using the modulating frequency determined based on the mobile body information, and decreasing the modulating frequency when a maximum value of a frequency of a sound output from the loudspeaker reaches a threshold value.

8. The sound output device according to claim 1, wherein
the generator generates a plurality of sound signals representing a plurality of sounds having different frequencies, the plurality of sound signals each being the sound signal, the plurality of sounds each being the sound,
the processing unit performs, as the predetermined process, generating, based on the mobile body information, an embellished sound signal representing an embellished sound for which the behavior of the mobile body is taken into consideration, and adding up the plurality of sound signals and the embellished sound signal, and
the outputter outputs the plurality of sound signals and the embellished sound signal that have been added up to the loudspeaker.

9. The sound output device according to claim 1, wherein
the processing unit performs the predetermined process on the sound signal under a condition that the total number of revolutions of the rotating body reaches a first threshold value, or that an amount of change per unit time of the total number of revolutions of the rotating body exceeds a second threshold value.

10. The sound output device according to claim 1, wherein
a plurality of loudspeakers that include the loudspeaker are provided in the mobile body, and
the sound output device dynamically switches a loudspeaker to which the sound signal is to be output, among the plurality of loudspeakers, the sound signal being a sound signal on which the predetermined process has been performed.

11. A mobile body that travels in a state in which the mobile body carries a user, the mobile body comprising:
a rotating body that generates rotational driving force;
the sound output device according to claim 1 that outputs the sound signal representing the sound for accentuating the rotating body sound emitted by the rotating body; and
a loudspeaker to which the sound signal received from the sound output device is input.
